(19) United States
(12) Patent Application Publication
(10) Pub. No.: US 2024/0089627 A1
(43) Pub. Date: Mar. 14, 2024

(54) VOLTAGE REGULATOR MODULE WITH SHARED STORAGE CAPACITOR ARCHITECTURE FOR DEPTH CAMERA ASSEMBLY

(71) Applicant: Meta Platforms Technologies, LLC, Menlo Park, CA (US)

(72) Inventor: Zhujie Lin, Fremont, CA (US)

(21) Appl. No.: 18/456,275

(22) Filed: Aug. 25, 2023

Related U.S. Application Data
(60) Provisional application No. 63/406,619, filed on Sep. 14, 2022.

(51) Int. Cl. H04N 25/709; H04N 13/254; H04N 13/344

(52) U.S. Cl. CPC H04N 25/709; H04N 13/254; H04N 13/344

(57) ABSTRACT

A charging circuit for a depth camera assembly (DCA) that can be integrated into a wearable device. The charging circuit includes a voltage regulation module (VRM) configured to generate a regulated voltage and a shared storage capacitor coupled to the VRM. The shared storage capacitor is charged using the regulated voltage during a non-exposure window of a DCA that includes an illuminator and a sensor array. The shared storage capacitor provides power to the illuminator and the sensor array during an exposure window of the DCA in which the illuminator emits light into a local area and the sensor array detects the light.

### CROSS REFERENCE TO RELATED APPLICATIONS

This application claims a priority and benefit to U.S. Provisional Patent Application Ser. No. 63/406,619, filed Sep. 14, 2022, which is hereby incorporated by reference in its entirety.

### FIELD OF THE INVENTION

The present disclosure relates generally to voltage regulation, and specifically relates to a voltage regulator module (VRM) with shared storage capacitor architecture for a depth camera assembly.

### BACKGROUND

Depth sensors are often used for depth determination. But the light sources and the associated imaging device (i.e., camera or sensor array) can have peak power demands during exposure. And depth sensors integrated into small factor devices may not have batteries capable of meeting the high peak power demand.

### SUMMARY

Embodiments of the present disclosure relate to a charging circuit for a depth camera assembly (DCA) that can be integrated into a wearable device. The charging circuit includes a voltage regulation module (VRM) configured to generate a regulated voltage and a shared storage capacitor coupled to the VRM. The shared storage capacitor is charged using the regulated voltage during a non-exposure window of a DCA that includes an illuminator and a sensor array. The shared storage capacitor provides power to the illuminator and the sensor array during an exposure window of the DCA in which the illuminator emits light into a local area and the sensor array detects the light.

Embodiments of the present disclosure further relate to a wearable device (e.g., smartwatch or a headset) that comprises a DCA, and a charging circuit coupled to the DCA. The DCA includes an illuminator and a sensor array. The charging circuit includes a VRM configured to generate a regulated voltage and a shared storage capacitor coupled to the VRM. The shared storage capacitor is charged using the regulated voltage during a non-exposure window of the DCA. The shared storage capacitor provides power to the illuminator and the sensor array during an exposure window of the DCA in which the illuminator emits light into a local area and the sensor array detects the light.

Embodiments of the present disclosure further relate to a method for charging a DCA that can be included into a wearable device (i.e., consumer electronic device, such as a headset, a smartwatch, etc.). The method comprises: charging, during a non-exposure window of a DCA that includes an illuminator and a sensor array, a shared storage capacitor using a regulated voltage from a VRM; and providing power from the shared storage capacitor to the illuminator and the sensor array during an exposure window of the DCA in which the illuminator emits light into a local area and the sensor array detects the light.

### BRIEF DESCRIPTION OF THE DRAWINGS

FIG. 1A is a perspective view of a headset implemented as a near-eye-display (NED), in accordance with one or more embodiments.

FIG. 1B is a cross-section of an eyewear of the headset in FIG. 1A, in accordance with one or more embodiments.

FIG. 2A is a perspective view of a headset implemented as a head-mounted display (HIMID), in accordance with one or more embodiments.

FIG. 2B is a cross section of a front rigid body of the headset in FIG. 2A, in accordance with one or more embodiments.

FIG. 3 illustrates an example charging circuit, in accordance with one or more embodiments.

FIG. 4 illustrates an example graph of various current, voltage and power outputs generated during operations of the charging circuit in FIG. 3, in accordance with one or more embodiments.

FIG. 5 is a flowchart illustrating a process of operating a charging circuit, in accordance with one or more embodiments.

FIG. 6 is a block diagram of a system environment that includes a headset, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Embodiments of the present disclosure relate to a voltage regulating system including a sequential voltage regulator module (VRM) and a shared storage capacitor. The voltage regulating system may be used to provide power to, e.g., an illuminator and sensor array of a depth camera assembly (DCA). The shared storage capacitor may be charged while the loads (i.e., the illuminator and the sensor array) are not drawing current, and when the loads draw current, the shared storage capacitor may discharge to provide power to the illuminator and the sensor array. A peak power provided by the shared storage capacitor to the loads may be greater than a peak power of the sequential VRM.

Embodiments of the present disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a head-mounted display (HMD) connected to a host computer system, a standalone HMD, a near-eye display (NED), a mobile device or computing system, or any other hardware platform capable of providing artificial reality content to one or more viewers.

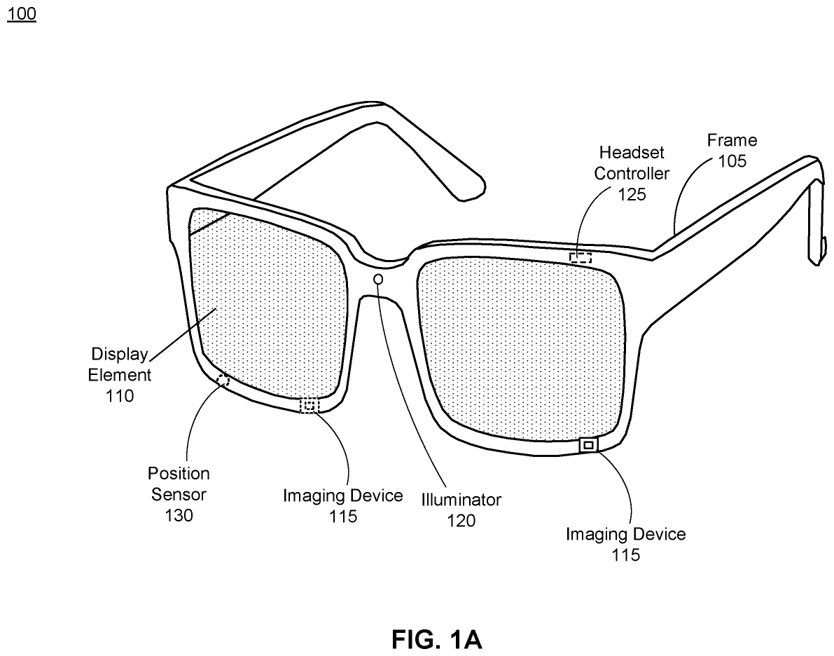

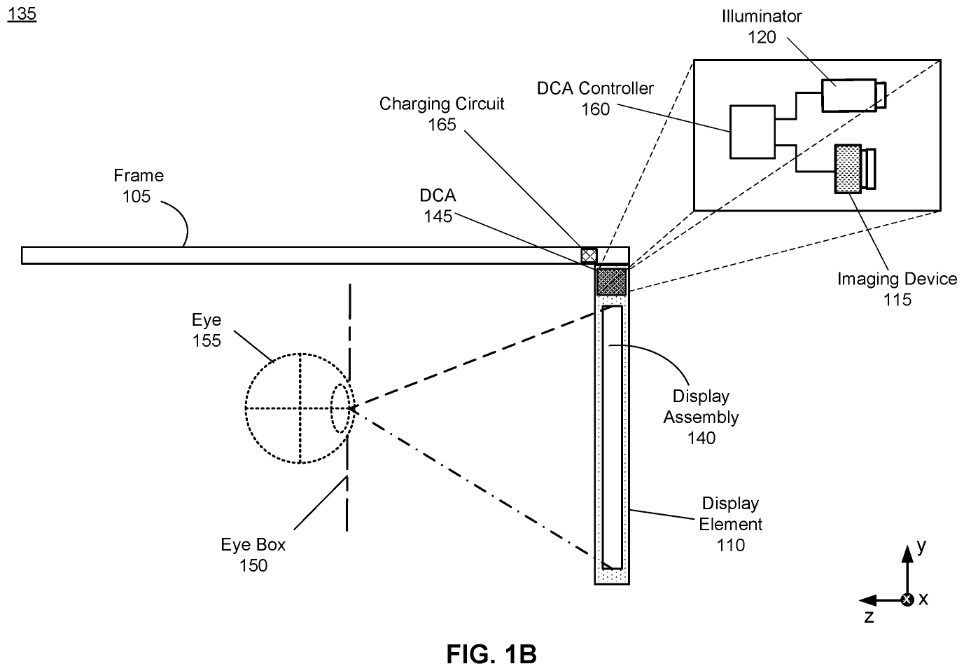

FIG. 1A is a perspective view of a headset 100 implemented as a NED, in accordance with one or more embodiments. In general, the headset 100 may be worn on the face of a user such that content (e.g., media content) is presented using one or display elements 110 of the headset 100. However, the headset 100 may also be used such that media content is presented to a user in a different manner. Examples of media content presented by the headset 100 include one or more images, video, audio, or some combination thereof. The headset 100 may include, among other components, a frame 105, a display assembly including one or more display elements 110, a DCA, a headset controller 125, and a position sensor 130. While FIG. 1A illustrates the components of the headset 100 in example locations on the headset 100, the components may be located elsewhere on the headset 100, on a peripheral device paired with the headset 100, or some combination thereof.

The headset 100 may correct or enhance the vision of a user, protect the eye of a user, or provide images to a user. The headset 100 may be a NED that produces artificial reality content for the user. The headset 100 may be eyeglasses which correct for defects in a user's eyesight. The headset 100 may be sunglasses which protect a user's eye from the sun. The headset 100 may be safety glasses which protect a user's eye from impact. The headset 100 may be a night vision device or infrared goggles to enhance a user's vision at night.

The frame 105 holds the other components of the headset 100. The headset 100 includes a front part that holds the one or more display elements 110 and end pieces to attach to a head of the user. The front part of the frame 105 bridges the top of a nose of the user. The end pieces (e.g., temples) are portions of the frame 105 to which the temples of a user are attached. The length of the end piece may be adjustable (e.g., adjustable temple length) to fit different users. The end piece may also include a portion that curls behind the ear of the user (e.g., temple tip, ear-piece).

The one or more display elements 110 provide light to a user wearing the headset 100. As illustrated, the headset 100 includes a display element 110 for each eye of a user. In some embodiments, a display element 110 generates image light that is provided to an eye box of the headset 100. The eye box is a location in space that an eye of user occupies while wearing the headset 100. For example, a display element 110 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eye box of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 110 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 110 are at least partially transparent, such that light from the local area may be combined with light from the one or more display elements to produce AR and/or MR content.

In some embodiments, a display element 110 does not generate image light, and instead is a lens that transmits light from the local area to the eye box. For example, one or both of the display elements 110 may be a lens without correction (non-prescription) or a prescription lens (e.g., single vision, bifocal and trifocal, or progressive) to help correct for defects in a user's eyesight. In some embodiments, the display element 110 is polarized and/or tinted to protect the user's eyes from the sun.

Note that in some embodiments, the display element 110 may include an additional optics block (not shown in FIG. 1A). The optics block may include one or more optical elements (e.g., lens, Fresnel lens, etc.) that direct light from the display element 110 to the eye box. The optics block may, e.g., correct for aberrations in some or all of the image content, magnify some or all of the image, or some combination thereof.

The DCA determines depth information for a portion of a local area surrounding the headset 100. The DCA includes one or more imaging devices 115, an illuminator 120, and a DCA controller (not shown in FIG. 1A). In some embodiments, the illuminator 120 illuminates a portion of the local area with light. The light may be, e.g., structured light (e.g., dot pattern, bars, etc.) in the infrared (IR), IR flash for time-of-flight, etc. In some embodiments, the one or more imaging devices 115 capture images of the portion of the local area that include the light from the illuminator 120. As illustrated, FIG. 1A shows a single illuminator 120 and two imaging devices 115.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 120), some other technique to determine depth of a scene, or some combination thereof.

Based on the determined depth information, the DCA controller may determine absolute positional information of the headset 100 within the local area. The DCA controller may also generate a model of the local area. The one or more imaging devices 115 may be integrated with the headset 100 or may be positioned within the local area external to the headset 100. In some embodiments, the DCA controller may provide the depth image data to the headset controller 125 integrated into the headset 100, e.g., for further processing and/or communication to some other component of an artificial reality system that includes the headset 100. The one or more imaging devices 115 may be part of simultaneous localization and mapping (SLAM) sensors mounted on the headset 100 for capturing visual information of a local area surrounding some or all of the headset 100. In some embodiments, each of the one or more imaging devices 115 includes an array of Single Photon Avalanche Diode (SPAD) sensors (i.e., sensor array).

The headset controller 125 may control operations of one or more components of the headset 100 including the illuminator 120. The headset controller 125 may receive the depth image data from the DCA controller and perform additional processing on the depth image data. In some embodiments, the headset controller 125 may control operations of components of an audio system integrated into the headset 100 (not shown in FIG. 1A). The headset controller 125 may include a communication module (e.g., a transceiver) for data communication (e.g., wireless communication) with some other external component of the artificial reality system, e.g., a server and/or a console (not shown in FIG. 1A).

The position sensor 130 generates one or more measurement signals in response to motion of the headset 100. The position sensor 130 may be located on a portion of the frame 105 of the headset 100. The position sensor 130 may include a position sensor, an inertial measurement unit (IMU), or both. Some embodiments of the headset 100 may or may not include the position sensor 130 or may include more than one position sensors 130. In embodiments in which the position sensor 130 includes an IMU, the IMU generates IMU data based on measurement signals from the position sensor 130. Examples of position sensor 130 include: one or more accelerometers, one or more gyroscopes, one or more magnetometers, another suitable type of sensor that detects motion, a type of sensor used for error correction of the IMU, or some combination thereof. The position sensor 130 may be located external to the IMU, internal to the IMU, or some combination thereof.

Based on the one or more measurement signals, the position sensor 130 estimates a current position of the headset 100 relative to an initial position of the headset 100. The estimated position may include a location of the headset 100 and/or an orientation of the headset 100 or the user's head wearing the headset 100, or some combination thereof. The orientation may correspond to a position of each ear relative to a reference point. In some embodiments, the position sensor 130 uses the depth information and/or the absolute positional information from the DCA to estimate the current position of the headset 100. The position sensor 130 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 100 from the sampled data. For example, the IMU integrates the measurement signals received from the accelerometers over time to estimate a velocity vector and integrates the velocity vector over time to determine an estimated position of a reference point on the headset 100. The reference point is a point that may be used to describe the position of the headset 100. While the reference point may generally be defined as a point in space, however, in practice the reference point is defined as a point within the headset 100.

FIG. 1B is a cross section 135 of an eyewear of the headset 100 illustrated in FIG. 1A, in accordance with one or more embodiments. The cross section 135 may include at least one display assembly 140 integrated into the display element 110, a DCA 145, an eye box 150, and a charging circuit 165. The eye box 150 is a location where an eye 155 is positioned when a user wears the headset 100. In some embodiments, the frame 105 may represent a frame of eyewear glasses. For purposes of illustration, FIG. 1B shows the cross section 135 associated with a single eye 155 and a single display assembly 140, but in alternative embodiments not shown, another display assembly which is separate from the display assembly 140 shown in FIG. 1, provides image light to another eye 155 of the user.

The display assembly 140 is configured to direct the image light to the eye 155 through the eye box 150. In some embodiments, when the headset 100 is configured as an AR NED, the display assembly 140 also directs light from a local area surrounding the headset 100 to the eye 155 through the eye box 150. The display assembly 140 may be configured to emit image light at a particular focal distance in accordance with varifocal instructions, e.g., provided from a varifocal module (not shown in FIG. 1).

The display assembly 140 may be composed of one or more materials (e.g., plastic, glass, etc.) with one or more refractive indices that effectively minimize the weight and present to the user a field of view of the headset 100. In alternate configurations, the headset 100 includes one or more optical elements between the display assembly 140 and the eye 155. The optical elements may act to, e.g., correct aberrations in image light emitted from the display assembly 140, magnify image light, perform some other optical adjustment of image light emitted from the display assembly 140, or some combination thereof. The example for optical elements may include an aperture, a Fresnel lens, a convex lens, a concave lens, a liquid crystal lens, a diffractive element, a waveguide, a filter, a polarizer, a diffuser, a fiber taper, one or more reflective surfaces, a polarizing reflective surface, a birefringent element, or any other suitable optical element that affects image light emitted from the display assembly 140.

The frame 105 further includes the DCA 145 configured to determine depth information for a portion of a local area surrounding the headset 100 (i.e., for one or more objects in the local area). For purposes of illustration, FIG. 1B shows the cross section 135 associated with a portion of the frame 105 including the DCA 145. However, the DCA 145 may be integrated into another portion of the frame 105. The DCA 145 includes the illuminator 120, the imaging device 115, and a DCA controller 160 that may be coupled to at least one of the illuminator 120 and the imaging device 115. In some embodiments (now shown in FIG. 1), the illuminator 120 and the imaging device 115 each may include its own internal controller. In some embodiments (not shown in FIG. 1), the illuminator 120 and the imaging device 115 can be widely separated, e.g., the illuminator 120 and the imaging device 115 can be located in different assemblies. In some embodiments (not shown in FIG. 1), the DCA 145 includes one or more additional imaging devices 115 and one or more additional illuminators 120.

The illuminator 120 may be configured to illuminate the local area with light in accordance with emission instructions generated by the DCA controller 160. The illuminator 120 may include an array of emitters, and at least a portion of the emitters in the array emit light simultaneously. In one or more embodiments, the illuminator 120 includes one or more arrays of vertical surface emitting lasers (VCSELs). At least the portion of the emitters in the array of the illuminator 120 may emit light in a near infra-red (NIR) spectrum, e.g., having one or more wavelengths between approximately 780 nm and 2500 nm. The emitted NIR light may be then projected into the scene by a projection lens of the illuminator 120 (not shown in FIG. 1). In or more embodiments, the illuminator 120 illuminates a portion of a local area with light. The light may be, e.g., structured light (e.g., dot pattern, bars, etc.) in the infrared (IR), IR flash for time-of-flight, etc. The illuminator 120 can be implemented as a versatile and yet power efficient NIR illuminator, which can be utilized with most depth sensing techniques, such as dToF depth sensing, indirect ToF depth sensing, structured light depth sensing, active stereo vision depth sensing, hybrid depth sensing combining structured light depth sensing and ToF based depth sensing, etc.

The imaging device 115 includes one or more cameras configured to capture one or more images of at least a portion of the light reflected from one or more objects in the local area. In one or more embodiments, the imaging device 115 captures images of a portion of the local area that includes the light from the illuminator 120. In one embodiment, the imaging device 115 is an infrared camera configured to capture images in a NIR spectrum. Additionally, the imaging device 115 may be also configured to capture images of visible spectrum light. The imaging device 115 may include a charge-coupled device (CCD) detector, a complementary metal-oxide-semiconductor (CMOS) detector, an array of SPAD array detectors (i.e., sensor array), or some other types of detectors (not shown in FIG. 1B). The imaging device 115 may be configured to operate with a frame rate in the range of approximately 30 Hz to approximately 1 KHz for fast detection of objects in the local area. In some embodiments, the imaging device 115 is deactivated for a defined amount of time before being activated again. Alternatively or additionally, the imaging device 115 can operate as instructed by the DCA controller 160 for single or multiple frames, up to a maximum frame rate, which can be in the kilohertz range.

The DCA controller 160 may generate the emission instructions and provide the emission instructions to the illuminator 120 for controlling operation of at least a portion of emitters in the emitter array in the illuminator 120 to emit light. The DCA controller 160 may control, based on the emission instructions, operation of the illuminator 120 to dynamically adjust a pattern of the light illuminating the local area, an intensity of the light pattern, a density of the light pattern, location of the light being projected at the local area, combination thereof, etc. The DCA controller 160 may be also configured to determine depth information for the one or more objects in the local area based in part on the one or more images captured by the imaging device 115. The DCA controller 160 may compute the depth information using one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator), some other technique to determine depth of a scene, or some combination thereof. In some embodiments, the DCA controller 160 provides the determined depth information to a console (not shown in FIG. 1B) and/or an appropriate module of the headset 100 (e.g., a varifocal module, not shown in FIG. 1). The console and/or the headset 100 may utilize the depth information to, e.g., generate content for presentation on the display assembly 140.

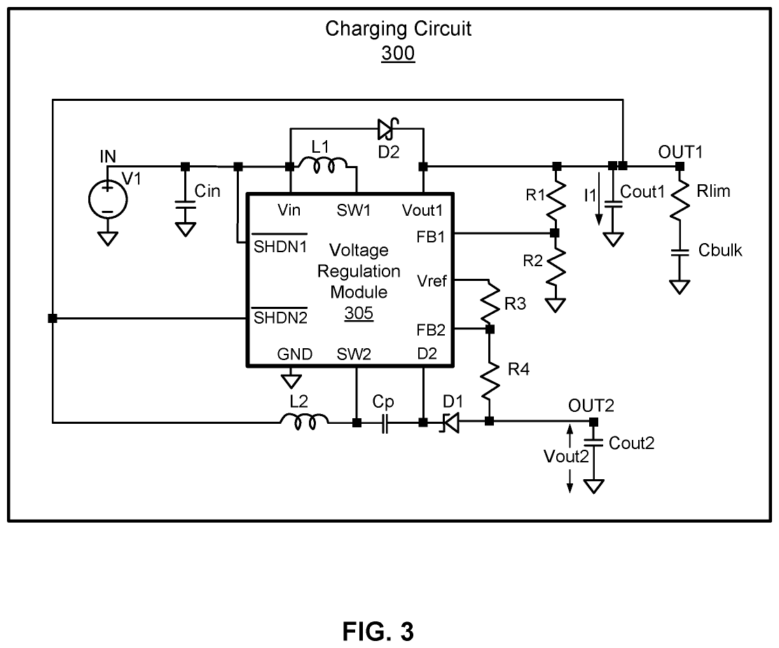

The charging circuit 165 may charge the illuminator 120 and the imaging device 115. The charging circuit 165 may include a VRM that generates a regulated voltage and a shared storage capacitor coupled to the VRM. The shared storage capacitor of the charging circuit 165 may be charged using the regulated voltage during a non-exposure window of the DCA 145. The shared storage capacitor of the charging circuit 165 may provide power to the illuminator 120 and the imaging device 115 during an exposure window of the DCA 145 in which the illuminator 120 emits light into a local area and the imaging device 115 detects the light reflected from the local area. Hence, the shared storage capacitor of the charging circuit 165 may be “shared” by the illuminator 120 and the imaging device 115. More details about a structure and operation of the charging circuit 165 are disclosed in conjunction with FIGS. 3 through 5.

In some embodiments, the headset 100 further includes an eye tracker (not shown in FIG. 1B) for determining and tracking a position of the eye 155, i.e., an angle and orientation of eye-gaze. Note that information about the position of the eye 155 also includes information about an orientation of the eye 155, i.e., information about user's eye-gaze. Based on the determined and tracked position and orientation of the eye 155, the headset 100 adjusts image light emitted from the display assembly 140. In some embodiments, the headset 100 adjusts focus of the image light and ensures that the image light is in focus at the determined angle of eye-gaze in order to mitigate the vergence-accommodation conflict. Additionally or alternatively, the headset 100 adjusts resolution of the image light by performing foveated rendering of the image light, based on the position of the eye 150. Additionally or alternatively, the headset 100 uses the information on a gaze position and orientation to provide contextual awareness for the user's attention, whether on real or virtual content. The eye tracker generally includes an illumination source and an imaging device (i.e., camera). In some embodiments, components of the eye tracker are integrated into the display assembly 140. In alternate embodiments, components of the eye tracker are integrated into the frame 105. In some embodiments, the illumination source of the eye tracker has the same structure and operates in the same manner as the projector 120.

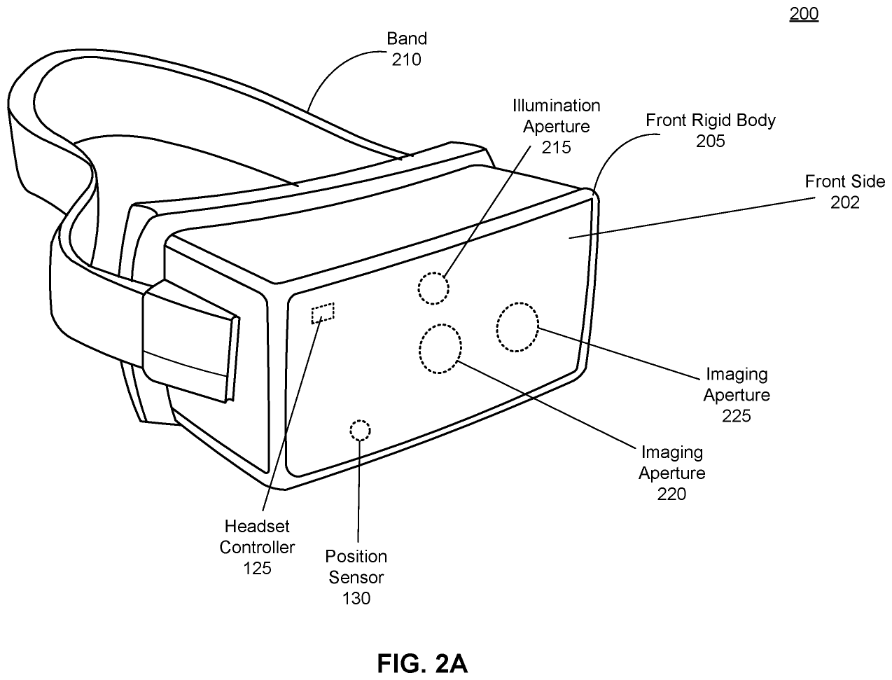

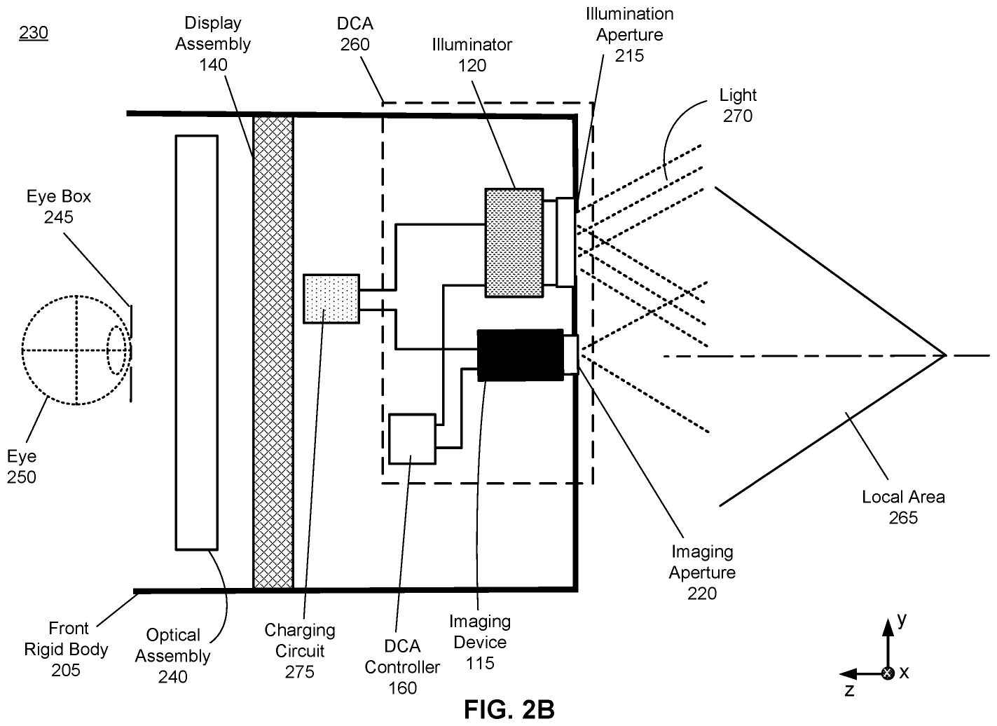

FIG. 2A is a perspective view of a headset 200 implemented as a HMD, in accordance with one or more embodiments. In embodiments that describe an AR system and/or a MR system, portions of a front side 202 of the headset 200 are at least partially transparent in the visible band (˜380 nm to 750 nm), and portions of the headset 200 that are between the front side 202 and an eye of the user are at least partially transparent (e.g., a partially transparent electronic display). The headset 200 includes a front rigid body 205 and a band 210. The headset 200 includes many of the same components described above with reference to FIG. 1A but modified to integrate with the HMD form factor. For example, the headset 200 includes a display assembly, a DCA, an audio system, and one or more position sensors 130. The front rigid body 205 includes one or more electronic display elements (not shown in FIG. 2A), one or more integrated eye tracking systems (not shown in FIG. 2A), and the one or more position sensors 130. The position sensors 130 may be located within an IMU, and neither the IMU nor the position sensors 130 are visible to a user of the headset 200.

FIG. 2A further shows an illumination aperture 215 associated with the illuminator 120, and imaging apertures 220, 225 associated with the imaging devices 115. The illuminator 120 emits light (e.g., a structured light pattern) through the illumination aperture 215. The one or more imaging devices 115 capture light that is reflected from the local area through at least one of the imaging apertures 220, 225.

FIG. 2B is a cross section 230 of the front rigid body 205 of the headset 200 shown in FIG. 2A, in accordance with one or more embodiments. As shown in FIG. 2B, the front rigid body 205 includes a display assembly 140 and an optical assembly 240 that together provide image light to an eye box 245. The eye box 245 is the location of the front rigid body 205 where a user's eye 250 is positioned. The eye-box 245 represents a three-dimensional volume at an output of the headset 200 in which the user's eye 250 is located to receive image light. For purposes of illustration, FIG. 2B shows a cross section 230 associated with a single eye 250, but another optical assembly 240, separate from the optical assembly 240, provides altered image light to another eye of the user. The front rigid body 205 also has an optical axis corresponding to a path along which image light propagates through the front rigid body 205.

The display assembly 140 generates image light. In some embodiments, the display assembly 140 includes an optical element that adjusts the focus of the generated image light. The display assembly 140 displays images to the user in accordance with data received from a console (not shown in FIG. 2B). In various embodiments, the display assembly 140 may comprise a single electronic display or multiple electronic displays (e.g., a display for each eye of a user). Examples of the display assembly 140 include: a liquid crystal display (LCD), an organic light emitting diode (OLED) display, an inorganic light emitting diode (ILED) display, an active-matrix organic light-emitting diode (AMOLED) display, a transparent organic light emitting diode (TOLED) display, some other display, a projector, or some combination thereof. The display assembly 140 may also include an aperture, a Fresnel lens, a convex lens, a concave lens, a diffractive element, a waveguide, a filter, a polarizer, a diffuser, a fiber taper, a reflective surface, a polarizing reflective surface, or any other suitable optical element that affects the image light emitted from the electronic display. In some embodiments, one or more of the display block optical elements may have one or more coatings, such as anti-reflective coatings.

The optical assembly 240 magnifies received light from the display assembly 140, corrects optical aberrations associated with the image light, and the corrected image light is presented to a user of the headset 200. At least one optical element of the optical assembly 240 may be an aperture, a Fresnel lens, a refractive lens, a reflective surface, a diffractive element, a waveguide, a filter, or any other suitable optical element that affects the image light emitted from the display assembly 140. Moreover, the optical assembly 240 may include combinations of different optical elements. In some embodiments, one or more of the optical elements in the optical assembly 240 may have one or more coatings, such as anti-reflective coatings, dichroic coatings, etc. Magnification of the image light by the optical assembly 240 allows elements of the display assembly 140 to be physically smaller, weigh less, and consume less power than larger displays. Additionally, magnification may increase a field-of-view of the displayed media. For example, the field-of-view of the displayed media is such that the displayed media is presented using almost all (e.g., 110 degrees diagonal), and in some cases all, of the user's field-of-view. In some embodiments, the optical assembly 240 is designed so its effective focal length is larger than the spacing to the display assembly 140, which magnifies the image light projected by the display assembly 140. Additionally, in some embodiments, the amount of magnification may be adjusted by adding or removing optical elements.

As shown in FIG. 2B, the front rigid body 205 further includes a DCA 260 for determining depth information of one or more objects in a local area 265 surrounding some or all of the headset 200. The DCA 260 includes an illuminator 120, one or more imaging devices 115, and a DCA controller 160. The illuminator 120 emits light 270 through the illumination aperture 215 in accordance with emission instructions generated by the DCA controller 160. The light 270 may be, e.g., structured light (e.g., dot pattern, bars, etc.) in the IR, IR flash for time-of-flight, etc. The imaging device 115 is configured to capture, through the imaging aperture 220, at least a portion of the light 270 reflected from one or more objects in the local area 265. The DCA controller 160 generates the emission instructions for the illuminator 120 for controlling operation of at least a portion of emitters in the array emitters within of the illuminator 120. The DCA controller 160 is also configured to determine depth information for one or more objects in the local area 265 based in part on the one or more images captured by the one or more imaging devices 115. In some embodiments, the DCA controller 160 provides the determined depth information to a console (not shown in FIG. 2B) and/or an appropriate module of the headset 200 (e.g., a varifocal module, not shown in FIG. 2B). The console and/or the headset 200 may utilize the depth information to, e.g., generate content for presentation on the display assembly 140.

In some embodiments, the front rigid body 205 further comprises an eye tracking system (not shown in FIG. 2B) that determines eye tracking information for the user's eye 250. The determined eye tracking information may comprise information about an orientation of the user's eye 250 in the eye box 245, i.e., information about an angle of an eye-gaze. In one embodiment, the user's eye 250 is illuminated with a structured light pattern generated by, e.g., the same type of an illumination source as the projector 120. The eye tracking system can use locations of the reflected structured light pattern in a captured image to determine eye position and eye-gaze. In another embodiment, the eye tracking system determines eye position and eye-gaze based on magnitudes of image light captured over a plurality of time instants.

In some embodiments, the front rigid body 205 further comprises a varifocal module (not shown in FIG. 2B). The varifocal module may adjust focus of one or more images displayed on the display assembly 140, based on the eye tracking information. In one embodiment, the varifocal module adjusts focus of the displayed images and mitigates vergence-accommodation conflict by adjusting a focal distance of the optical assembly 240 based on the determined eye tracking information. In another embodiment, the varifocal module adjusts focus of the displayed images by performing foveated rendering of the one or more images based on the determined eye tracking information. In yet another embodiment, the varifocal module utilizes the depth information from the DCA controller 160 to generate content for presentation on the display assembly 140.

As shown in FIG. 2B, the front rigid body 205 further includes a charging circuit 275 for charging the illuminator 120 and the imaging device 115. The charging circuit 275 may include a VRM that generates a regulated voltage and a shared storage capacitor coupled to the VRM. The shared storage capacitor of the charging circuit 275 may be charged using the regulated voltage during a non-exposure window of the DCA 260. The shared storage capacitor of the charging circuit 275 may provide power to both the illuminator 120 and the imaging device 115 during an exposure window of the DCA 260 in which the illuminator 120 emits the light 270 into the local area 265 and the imaging device 115 detects portions of the light 270 reflected from the local area 265. Hence, the shared storage capacitor of the charging circuit 275 may be “shared” by the illuminator 120 and the imaging device 115. More details about a structure and operation of the charging circuit 275 are disclosed in conjunction with FIGS. 3 through 5.

FIG. 3 illustrates an example charging circuit 300, in accordance with one or more embodiments. The charging circuit 300 may be integrated into an electronic wearable device (e.g., headset, smartwatch, etc.) to provide power to components of a DCA (e.g., also integrated into the electronic wearable device), such as one or more illuminators (e.g., one or more illuminators 120) and a sensor array (e.g., one or more imaging devices 115). The charging circuit 300 may include a VRM 305, a shared storage capacitor, Cbulk, inductors, capacitors, resistors, diodes (e.g., diodes D1 and D2 in FIG. 3), and a switch (e.g., S1 in FIG. 3). The shared storage capacitor, Cbulk, and other passive components of the charging circuit 300 may be coupled either directly or indirectly to the VRM 305. The charging circuit 300 may include fewer or additional components than what is shown in FIG. 3. The charging circuit 300 may be an embodiment of the charging circuit 165 and the charging circuit 275.

In one or more embodiments, the VRM 305 includes at least one of: one or more switching regulator circuits, one or more inductors, one or more capacitors, one or more resistors, one or more diodes, and one or more metal-oxide-semiconductor field-effect transistors (MOSFETs). The VRM 305 may operate as a dual converter that includes a boost converter (or boost regulator circuit) and an inverting converter (or inverting regulator circuit). Thus, the VRM 305 may operate as a dual converter or dual voltage regulator that provides a first regulated voltage boosted relative to an input voltage (e.g., relative to a voltage source V1 in FIG. 3) as well as a second regulated voltage independent from the first regulated voltage but with an inverted sign relative to the first (boosted) regulated voltage. For example, the first regulated voltage may be positive, whereas the second regulated voltage may be negative.

The VRM 305 may be configured to provide power to components of the DCA (e.g., to the one or more illuminators and the sensor array) via the shared storage capacitor, Cbulk. The VRM 305 may receive power from one or more batteries (e.g., the voltage source V1) and output the first regulated voltage, which is a voltage at a pin “Vout1” of the VRM 305. The first regulated voltage may be then provided to the one or more illuminators at an output port OUT1 via the shared storage capacitor, Cbulk. In one or more embodiments, the VRM 305 steps up (i.e., boost) a voltage provided by the one or more batteries when generating the first regulated voltage. Alternatively, the VRM 305 may step down a voltage provided by the one or more batteries when generating the first regulated voltage. The shared storage capacitor, Cbulk, and the VRM 305 may further provide the second regulated voltage to the sensor array at an output port OUT2.

Note that “Vin” in FIG. 3 is a pin of the VRM 305 that may be used to provide an input voltage to the VRM 305; “SW1” is a pin of the VRM 305 that may be used to provide a switching signal to a first switching regulator circuit of the VRM 305 (e.g., boost regulator circuit); “Vout1” is a pin of the VRM 305 that may be used to provide an output voltage (i.e., regulated voltage) of the VRM 305; “FB1” is a pin of the VRM 305 that that may be used to provide a first feedback signal to the VRM 305 for regulating a voltage at the output port OUT1; “Vref” is a pin of the VRM 305 that may be used to provide a reference voltage to the VRM 305; “FB2” is a pin of the VRM 305 that may be used to provide a second feedback signal to the VRM 305 for regulating a voltage Vout2 at the output port OUT2; “D2” is a pin of the VRM 305 that may be used to provide one or more signals to one or more diodes of the VRM 305: “SW2” is a pin of the VRM 305 that may be used to provide a switching signal to a second switching regulator circuit of the VRM 305 (e.g., inverting regulator circuit); “GND” is a ground pin of the VRM 305; “S̅H̅D̅N̅1̅” is a first shutdown pin of the VRM 305 that is activated by a low-level voltage signal; and “S̅H̅D̅N̅2̅” is a second shutdown pin of the VRM 305 that is activated by a low-level voltage signal. Example for inductances, capacitances, and resistances associated with passive components of the charging circuit 300 are: L1=L2=10 μH, Cin=1 μF, Cp=0.2 μF, Cout1=0.01 μF, Cout2=1 μF, R1=1 MΩ, R2=66 KΩ, R3=43.5 KΩ, R4=1 MΩ, R5=1.5 KΩ, Rlim=1Ω. The shared storage capacitor, Cbulk, may be implemented as a pair of capacitors connected in parallel, each individual capacitor having a capacitance of, e.g., 22 μF.

Each of the first regulated voltage generated by the VRM 305 at the pin “Vout1” and the second regulated voltage Vout2 generated at the output port OUT2 may be either positive or negative. Alternatively, the first regulated voltage may be strictly positive (e.g., when the VRM receives power from a positive rail), and the second regulated voltage may be strictly negative. A current signal Il in FIG. 3 (e.g., current flowing through the capacitor Cout1) may represent current for supplying the one or more illuminators; and OUT1 in FIG. 3 may represent an output port of the charging circuit 300 for providing power (i.e., voltage and current) to the one or more illuminators. A voltage signal Vout2 in FIG. 3 (e.g., voltage at the capacitor Cout2) may represent a voltage for supplying the sensor array (i.e., one or more imaging devices) of the DCA; and OUT2 in FIG. 3 may represent an output port of the charging circuit 300 for providing power (i.e., voltage and current) to the sensor array.

The shared storage capacitor architecture of the charging circuit 300 may enable the VRM 305 to effectively service variable power demands of the DCA. The power demands of the DCA may vary based on whether the DCA is operating within an exposure window. The exposure window is a time window when the sensor array of the DCA is imaging, while one or more illuminators of the DCA are emitting light, or some combination thereof. Time windows of the DCA outside an exposure window are referred to as non-exposure windows.

The shared storage capacitor architecture of the charging circuit 300 may utilize the single storage capacitor, Cbulk, to service the sensor array and/or the one or more illuminators of the DCA. The single storage capacitor, Cbulk, may be integrated within the charging circuit 300 along with the VRM 305 to provide, e.g., a positive voltage to the one or more illuminators and a negative voltage to the sensor array. The positive voltage may be provided to the one or more illuminators at the output port OUT1 via, e.g., the boost regulator circuit of the VRM 305 and the pin “Vout1”. The shared storage capacitor, Cbulk, may provide input power to the inverting regulator circuit of the VRM 305 (e.g., via the pin “Vin”). Based on the input power obtained via the shared storage capacitor, Cbulk, the inverting regulator circuit of the VRM 305 may then provide (e.g., via the pin “SW2”) the negative voltage Vout2 to the sensor array at the output port OUT2.

The shared storage capacitor, Cbulk, may be connected to a positive rail of the charging circuit 300, whereas a negative rail of the charging circuit 300 may be provided by the VRM 305 (e.g., via the inverting regulator circuit of the VRM 305). The shared storage capacitor, Cbulk, may further protect a system voltage (i.e., the voltage V1 in FIG. 3) from experiencing the peak loads during the exposure windows. In this manner, the shared storage capacitor, Cbulk, may provide more power (over an exposure window) than a power level output by the VRM 305.

The VRM 305 along with the shared storage capacitor, Cbulk, and other components of the charging circuit 300 may service peak loads of the components of the DCA during exposure windows of the DCA, whereas the shared storage capacitor, Cbulk, may be re-charged during non-exposure windows of the DCA. By employing the shared storage capacitor, Cbulk, along with the VRM 305, a battery of the DCA may be subject to the slow charging current—and, thus, may be protected from surges in current during the exposure windows. In this manner, the DCA and the wearable electronic device may avoid the brownout conditions during the exposure windows (i.e., times where the DCA has a high-power demand).

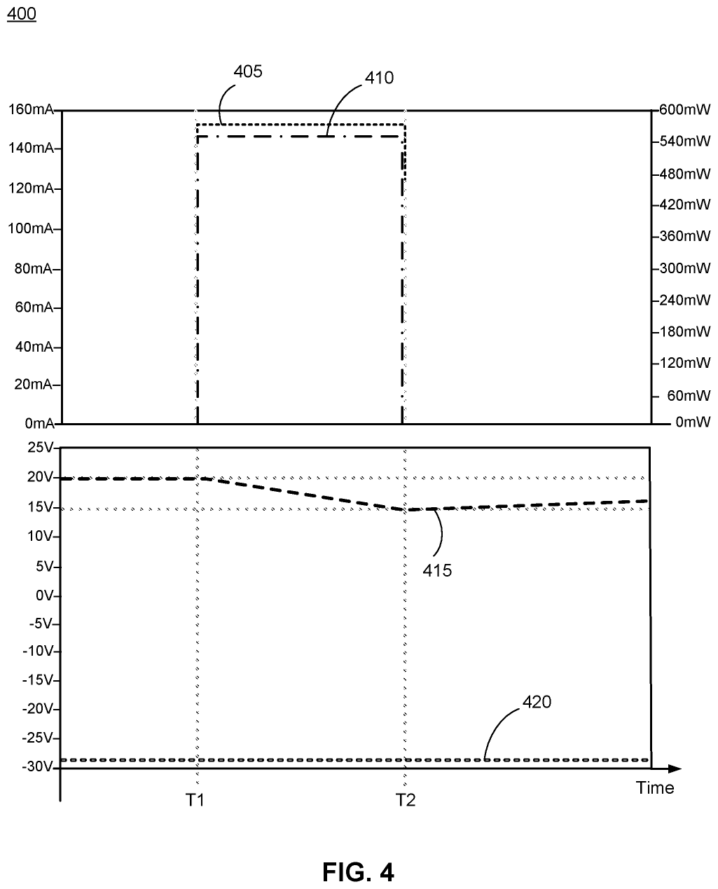

FIG. 4 illustrates an example graph 400 of various current, voltage and power outputs generated during operations of the charging circuit 300, in accordance with one or more embodiments. The current, voltage and power outputs shown in FIG. 4 may be generated by employing the VRM 305 and the shared storage capacitor architecture of the charging circuit 300 over both an exposure window and non-exposure windows of the DCA. The exposure window in FIG. 4 occurs between a first time instant T1 and a second time instant T2, and the non-exposure windows occur before and after the exposure window (i.e., before the first time instant T1 and after the second time instant T2).

A plot 405 in the graph 400 corresponds to the current signal, Il, provided to the one or more illuminators (e.g., VCSEL load) coupled to the OUT1 port of the charging circuit 300. A plot 410 in the graph 400 corresponds to the power provided to the sensor array (e.g., SPAD load) coupled to the OUT2 port of the charging circuit 300. A plot 415 in the graph 400 corresponds to the voltage signal, Vout1, provided to the one or more illuminators (e.g., VCSEL load) coupled to the OUT1 port of the charging circuit 300. A plot 420 in the graph 400 corresponds to the voltage signal, Vout2, provided to the sensor array (e.g., SPAD load) coupled to the OUT2 port of the charging circuit 300. Note that during the exposure window (i.e., between the time intervals T1 and T2 in FIG. 4), the charging circuit 300 provides power to both the one or more illuminators and the sensor array. Once the exposure window is over (i.e., after the second time interval T2), the shared storage capacitor, Cbulk, charges as the voltage signal, Vout1, that is proportional to a charge at the shared storage capacitor, Cbulk, increases.

### Process Flow

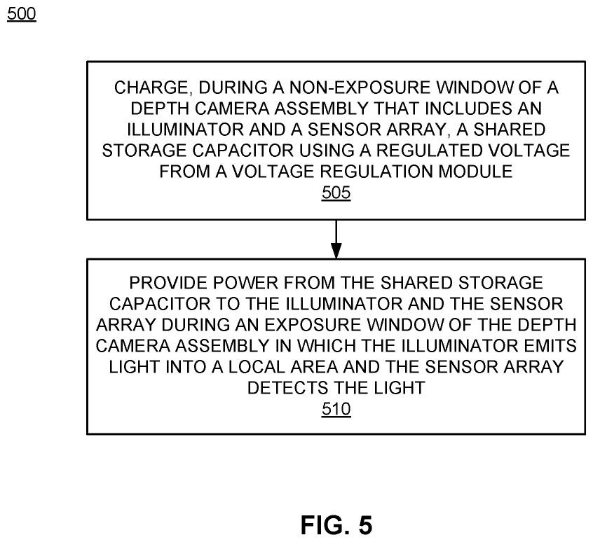

FIG. 5 is a flowchart illustrating a process 500 for operating a charging circuit, in accordance with one or more embodiments. The process 500 shown in FIG. 5 may be performed by, e.g., the charging circuit 300. The charging circuit may be configured for charging components of a DCA. The charging circuit and the DCA may be capable of being part of a headset, a smartwatch, or some other wearable electronic device. The DCA may be configured as, e.g., a dToF-based depth sensing system. Other entities may perform some or all of the steps in FIG. 5 in other embodiments. Embodiments may include different and/or additional steps, or perform the steps in different orders.

The charging circuit charges 505, during a non-exposure window of a DCA that includes an illuminator and a sensor array, a shared storage capacitor using a regulated voltage from a VRM. The charging circuit may include one or more batteries that provide input power to the VRM. The regulated voltage may be stepped up from one or more voltages provided by the one or more batteries. Alternatively, the regulated voltage may be stepped down from one or more voltages provided by the one or more batteries. The VRM may include a first switching regulator circuit (e.g., boost converter or boost regulator circuit) and a second switching regulator circuit (e.g., inverting converter or inverting regulator circuit). The first switching regulator circuit may generate the regulated voltage of a positive level for the illuminator. The shared storage capacitor may provide input power to the second switching regulator circuit, and the second switching regulator circuit may generate, using the input power from the shared storage capacitor, another regulated voltage of a negative level for the sensor array. In one or more embodiments, the voltage regulator includes at least one of one or more switching regulator circuits, one or more inductors, one or more capacitors, one or more resistors, one or more diodes, and one or more MOSFETs. The shared storage capacitor may be coupled to a positive rail of the charging circuit, and a negative rail of the charging circuit may be provided by the VRM.

The charging circuit provides 510 power from the shared storage capacitor to the illuminator and the sensor array during an exposure window of the DCA in which the illuminator emits light into a local area and the sensor array detects the light. The charging circuit may provide the power from the shared storage capacitor to the illuminator and the sensor array that is more than a power level output by the VRM. The shared storage capacitor may provide to the illuminator a positive voltage generated by the VRM. Furthermore, the shared storage capacitor may provide, via the VRM (e.g., via the inverting regulator circuit), a negative voltage to the sensor array. The shared storage capacitor may be configured to protect a voltage provided to the illuminator from experiencing one or more peaks during the exposure window. The shared storage capacitor may provide a current of a defined current amplitude to the illuminator and a voltage of a defined voltage amplitude to the sensor array.

Note that conventional VRM schemes are not well suited for wearable electronic devices—which tend to have very small form factors. For example, a conventional VRM would use large batteries to service large power demands—but large batteries are not feasible in most wearable electronic devices (e.g., headsets, smart watches, etc.). In contrast, the use of the VRM with a shared storage capacitor architecture presented in this disclosure can service the power demands of the DCA while using a relatively small battery—thereby enabling use with small form factor devices where conventional solutions fail. Moreover, the use of the VRM with the shared storage capacitor architecture presented herein can mitigate, during the exposure windows, likelihoods for occurrence of brownout conditions on other components that share the same battery as the DCA.

### System Environment

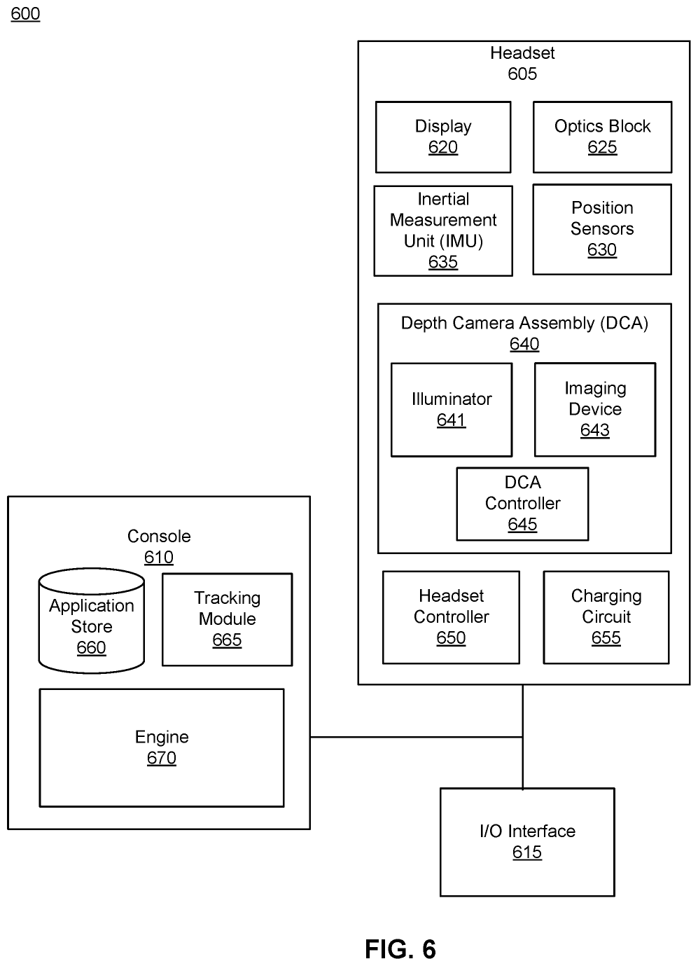

FIG. 6 is a block diagram of a system environment that includes a headset, in accordance with one or more embodiments. The system 600 may operate in an artificial reality environment, e.g., a virtual reality, an augmented reality, a mixed reality environment, or some combination thereof. The system 600 shown by FIG. 6 comprises a headset 605 and an input/output (I/O) interface 615 that is coupled to a console 610. While FIG. 6 shows an example system 600 including one headset 605 and on I/O interface 615, in other embodiments any number of these components may be included in the system 600. For example, there may be multiple headsets 605 each having an associated I/O interface 615, with each headset 605 and I/O interface 615 communicating with the console 610. In alternative configurations, different and/or additional components may be included in the system 600. Additionally, functionality described in conjunction with one or more of the components shown in FIG. 6 may be distributed among the components in a different manner than described in conjunction with FIG. 6 in some embodiments. For example, some or all of the functionality of the console 610 is provided by the headset 605.

The headset 605 is a NED or a HMD that presents content to a user comprising virtual and/or augmented views of a physical, real-world environment with computer-generated elements (e.g., two-dimensional or three-dimensional images, two-dimensional or three-dimensional video, sound, etc.). In some embodiments, the presented content includes audio that is presented via an external device (e.g., speakers and/or headphones) that receives audio information from the headset 605, the console 610, or both, and presents audio data based on the audio information. The headset 605 may comprise one or more rigid bodies, which may be rigidly or non-rigidly coupled together. A rigid coupling between rigid bodies causes the coupled rigid bodies to act as a single rigid entity. In contrast, a non-rigid coupling between rigid bodies allows the rigid bodies to move relative to each other. An embodiment of the headset 605 is the headset 100 of FIG. 1A implemented as a NED. Another embodiment of the headset 605 is the headset 200 of FIG. 2A implemented as a HMD.

The headset 605 may include a display 620, an optics block 625, one or more position sensors 630, an IMU 635, a DCA 640, a headset controller 650, and a charging circuit 655. Some embodiments of the headset 605 have different and/or additional components than those described in conjunction with FIG. 6. Additionally, the functionality provided by various components described in conjunction with FIG. 6 may be differently distributed among the components of the headset 605 in other embodiments.

The display 620 displays two-dimensional or three-dimensional images to the user in accordance with data received from the console 610. In various embodiments, the display 620 comprises a single display or multiple displays (e.g., a display for each eye of a user). Examples of the display 620 include: a liquid crystal display (LCD), an organic light emitting diode (OLED) display, an inorganic light emitting diode (ILED) display, an active-matrix organic light-emitting diode (AMOLED) display, a transparent organic light emitting diode (TOLED) display, a laser-based display, one or more waveguides, some other display, a scanner, one-dimensional array, or some combination thereof. Content displayed on the display 620 may include the depth information determined by the DCA 640. An embodiment of the display 620 is the display assembly 140.

The optics block 625 magnifies image light received from the display 620, corrects optical errors associated with the image light, and presents the corrected image light to a user of the headset 605. In various embodiments, the optics block 625 includes one or more optical elements. Example optical elements included in the optics block 625 include: an aperture, a Fresnel lens, a convex lens, a concave lens, a filter, a reflecting surface, or any other suitable optical element that affects image light. Moreover, the optics block 625 may include combinations of different optical elements. In some embodiments, one or more of the optical elements in the optics block 625 may have one or more coatings, such as partially reflective or anti-reflective coatings.

Magnification and focusing of the image light by the optics block 625 allows the display 620 to be physically smaller, weigh less, and consume less power than larger displays. Additionally, magnification may increase the field of view of the content presented by the display 620. For example, the field of view of the displayed content is such that the displayed content is presented using almost all (e.g., approximately 110 degrees diagonal), and in some cases all, of the user's field of view. Additionally, in some embodiments, the amount of magnification may be adjusted by adding or removing optical elements.

In some embodiments, the optics block 625 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 625 corrects the distortion when it receives image light from the electronic display generated based on the content. An embodiment of the optics block 625 is the optical assembly 240.

The IMU 635 is an electronic device that generates data indicating a position of the headset 605 based on measurement signals received from one or more of the position sensors 630. A position sensor 630 generates one or more measurement signals in response to motion of the headset 605. Examples of position sensors 630 include: one or more accelerometers, one or more gyroscopes, one or more magnetometers, another suitable type of sensor that detects motion, a type of sensor used for error correction of the IMU 635, or some combination thereof. The position sensors 630 may be located external to the IMU 635, internal to the IMU 635, or some combination thereof. An embodiment of the position sensor 635 is the position sensor 130.

The DCA 640 includes an illuminator 641, an imaging device 643 and a DCA controller 645. The DCA 640 generates depth image data of a local area surrounding some or all of the headset 605. Depth image data includes pixel values defining distance from the imaging device, and thus provides a (e.g., 3D) mapping of locations captured in the depth image data. An embodiment of the DCA 640 is the DCA 145 of FIG. 1B or the DCA 260 of FIG. 2B, an embodiment of the illuminator 641 is the projector 120, an embodiment of the imaging device 643 is the imaging device 115, and an embodiment of the DCA controller 645 is the DCA controller 160. The DCA 640 may generates depth image data using the dToF depth sensing technique, or some other depth sensing technique. The DCA 640 may generate the depth image data based on time required to light to be emitted from the illuminator 641 until at least a portion of the light reflected from one or more objects in the local area is captured by the imaging device 643.

The illuminator 641 may include an array of emitters. Operation of at least a portion of the array of emitters may be controlled based in part on emission instructions to emit light. The light from the illuminator 641 may illuminate a local area surrounding the headset 605. In some embodiments, the same type of the projector as the illuminator 641 can be part of an eye tracker integrated into a headset 605 (not shown in FIG. 6) that illuminates one of more surfaces of an eye located in an eye box of the headset 605. The eye tracker may capture light reflected from the one of more eye surfaces and determine a gaze direction for the eye based on the captured light.

The DCA controller 645 may generate emission instructions and provide the emission instructions to the illuminator 641 to control operation of at least a portion of the emitters in the illuminator 641. In one embodiment, the DCA controller 645 controls operation of at least the portion of emitters in the illuminator 641 by controlling at least one column of the emitters. In another embodiment, the DCA controller 645 controls operation of at least the portion of emitters in the illuminator 641 by controlling operation of at least one emitter in the array of emitters. The DCA controller 645 may further generate the depth image data based on light captured by the imaging device 643 by using, e.g., time-of-flight depth sensing techniques. The DCA controller 645 may provide the depth image data to the console 610, the headset controller 650, or some other component. In some embodiments, the DCA controller 645 controls operation of one or more emitters in the illuminator 641, based at least in part on the depth image data.

The charging circuit 655 may provide power to the illuminator 641 and the imaging device 643 (e.g., sensor array). The charging circuit 655 may include a VRM that generates a regulated voltage and a shared storage capacitor coupled to the VRM. The shared storage capacitor of the charging circuit 655 may be charged using the regulated voltage during a non-exposure window of the DCA 640. The shared storage capacitor of the charging circuit 655 may provide power to the illuminator 641 and the imaging device 643 during an exposure window of the DCA 640 in which the illuminator 641 emits light into a local area and the imaging device 643 detects the light reflected from the local area. The power provided by the shared storage capacitor of the charging circuit 655 may be more than a power level output by the VRM of the charging circuit 655. The charging circuit 655 may be an embodiment of the charging circuit 300.

The I/O interface 615 is a device that allows a user to send action requests and receive responses from the console 610. An action request is a request to perform a particular action. For example, an action request may be an instruction to start or end capture of image or video data or an instruction to perform a particular action within an application. The I/O interface 615 may include one or more input devices. Example input devices include: a keyboard, a mouse, a game controller, or any other suitable device for receiving action requests and communicating the action requests to the console 610. An action request received by the I/O interface 615 is communicated to the console 610, which performs an action corresponding to the action request. In some embodiments, the I/O interface 615 includes an IMU 635 that captures calibration data indicating an estimated position of the I/O interface 615 relative to an initial position of the I/O interface 615. In some embodiments, the I/O interface 615 may provide haptic feedback to the user in accordance with instructions received from the console 610. For example, haptic feedback is provided when an action request is received, or the console 610 communicates instructions to the I/O interface 615 causing the I/O interface 615 to generate haptic feedback when the console 610 performs an action.

The console 610 provides content to the headset 605 for processing in accordance with information received from one or more of: the DCA 640, the headset controller 650, and the I/O interface 615. In the example shown in FIG. 6, the console 610 includes an application store 660, a tracking module 665, and an engine 670. Some embodiments of the console 610 have different modules or components than those described in conjunction with FIG. 6. Similarly, the functions further described below may be distributed among components of the console 610 in a different manner than described in conjunction with FIG. 6.

The application store 660 stores one or more applications for execution by the console 610. An application is a group of instructions, that when executed by a processor, generates content for presentation to the user. Content generated by an application may be in response to inputs received from the user via movement of the headset 605 or the I/O interface 615. Examples of applications include: gaming applications, conferencing applications, video playback applications, or other suitable applications.

The tracking module 665 calibrates the system 600 using one or more calibration parameters and may adjust one or more calibration parameters to reduce error in determination of the position of the headset 605 or of the I/O interface 615. For example, the tracking module 665 communicates a calibration parameter to the DCA 640 to adjust the focus of the DCA 640 to more accurately determine positions of structured light elements captured by the DCA 640. Calibration performed by the tracking module 665 also accounts for information received from the IMU 635 in the headset 605 and/or an IMU included in the I/O interface 615. Additionally, if tracking of the headset 605 is lost (e.g., the DCA 640 loses line of sight of at least a threshold number of structured light elements), the tracking module 665 may re-calibrate some or all of the system 600.

The tracking module 665 tracks movements of the headset 605 or of the I/O interface 615 using information from the DCA 640, the one or more position sensors 630, the IMU 635, or some combination thereof. For example, the tracking module 665 determines a position of a reference point of the headset 605 in a mapping of a local area based on information from the headset 605. The tracking module 665 may also determine positions of the reference point of the headset 605 or a reference point of the I/O interface 615 using data indicating a position of the headset 605 from the IMU 635 or using data indicating a position of the I/O interface 615 from an IMU 635 included in the I/O interface 615, respectively. Additionally, in some embodiments, the tracking module 665 may use portions of data indicating a position or the headset 605 from the IMU 625 as well as representations of the local area from the DCA 640 to predict a future location of the headset 605. The tracking module 665 provides the estimated or predicted future position of the headset 605 or the I/O interface 615 to the engine 670.

The engine 670 generates a three-dimensional mapping of the area surrounding the headset 605 (i.e., the “local area”) based on information received from the headset 605. In some embodiments, the engine 670 determines depth information for the three-dimensional mapping of the local area based on information received from the DCA 640 that is relevant for techniques used in computing depth. The engine 670 may calculate depth information using one or more techniques in computing depth from the portion of the reflected light detected by the DCA 640, such as the time-of-flight techniques, the stereo based techniques, the structured light illumination techniques, and. In various embodiments, the engine 670 uses the depth information to, e.g., update a model of the local area, and generate content based in part on the updated model.

The engine 670 also executes applications within the system 600 and receives position information, acceleration information, velocity information, predicted future positions, or some combination thereof, of the headset 605 from the tracking module 665. Based on the received information, the engine 670 determines content to provide to the headset 605 for presentation to the user. For example, if the received information indicates that the user has looked to the left, the engine 670 generates content for the headset 605 that mirrors the user's movement in a virtual environment or in an environment augmenting the local area with additional content. Additionally, the engine 670 performs an action within an application executing on the console 610 in response to an action request received from the I/O interface 615 and provides feedback to the user that the action was performed. The provided feedback may be visual or audible feedback via the headset 605 or haptic feedback via the I/O interface 615.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A charging circuit comprising:
a voltage regulation module (VRM) configured to generate a regulated voltage; and
a shared storage capacitor coupled to the VRM, wherein
the shared storage capacitor is charged using the regulated voltage during a non-exposure window of a depth camera assembly (DCA) that includes an illuminator and a sensor array, and
the shared storage capacitor provides power to the illuminator and the sensor array during an exposure window of the DCA in which the illuminator emits light into a local area and the sensor array detects the light.

2. The charging circuit of claim 1, further comprising one or more batteries that provide input power to the VRM.

3. The charging circuit of claim 2, wherein the regulated voltage is stepped up from one or more voltages provided by the one or more batteries.

4. The charging circuit of claim 2, wherein the regulated voltage is stepped down from one or more voltages provided by the one or more batteries.

5. The charging circuit of claim 1, wherein the VRM includes a first switching regulator circuit and a second switching regulator circuit.

6. The charging circuit of claim 5, wherein:
the first switching regulator circuit generates the regulated voltage of a positive level for the illuminator;
the shared storage capacitor provides input power to the second switching regulator circuit; and
the second switching regulator circuit generates, using the input power from the shared storage capacitor, another regulated voltage of a negative level for the sensor array.

7. The charging circuit of claim 1, wherein the VRM comprises at least one of: one or more switching regulator circuit, one or more inductors, one or more capacitors, one or more resistors, one or more diodes, and one or more metal-oxide-semiconductor field-effect transistors.

8. The charging circuit of claim 1, wherein the power provided by the shared storage capacitor is more than a power level output by the VRM.

9. The charging circuit of claim 1, wherein the shared storage capacitor is coupled to a positive rail of the charging circuit, and a negative rail of the charging circuit is provided by the VRM.

10. The charging circuit of claim 1, wherein:
wherein the shared storage capacitor provides to the illuminator a positive voltage generated by the VRM; and
the shared storage capacitor provides, via the VRM, a negative voltage to the sensor array.

11. The charging circuit of claim 1, wherein the shared storage capacitor provides a current of a defined current amplitude to the illuminator and a voltage of a defined voltage amplitude to the sensor array.

12. The charging circuit of claim 1, wherein the charging circuit and the DCA are capable of being part of a headset.

13. The charging circuit of claim 1, wherein the charging circuit and the DCA are capable of being part of a smartwatch.

14. A wearable device comprising:
a depth camera assembly (DCA) that includes an illuminator and a sensor array; and
a charging circuit coupled to the DCA, the charging circuit including:
a voltage regulation module (VRM) configured to generate a regulated voltage, and
a shared storage capacitor coupled to the VRM, wherein
the shared storage capacitor is charged using the regulated voltage during a non-exposure window of the DCA, and
the shared storage capacitor provides power to the illuminator and the sensor array during an exposure window of the DCA in which the illuminator emits light into a local area and the sensor array detects the light.

15. The wearable device of claim 14, wherein the power provided by the shared storage capacitor is more than a power level output by the VRM.

16. The wearable device of claim 14, wherein:
the VRM includes a first switching regulator circuit and a second switching regulator circuit;
the first switching regulator circuit generates the regulated voltage of a positive level for the illuminator;
the shared storage capacitor provides input power to the second switching regulator circuit; and
the second switching regulator circuit generates using the input power another regulated voltage of a negative level for the sensor array.

17. The wearable device of claim 14, wherein the shared storage capacitor is configured to protect a voltage provided to the illuminator from experiencing one or more peaks during the exposure window.

18. The wearable device of claim 14, wherein the DCA is configured as a direct time-of-flight (dToF) depth sensing system.

19. A method comprising:
charging, during a non-exposure window of a depth camera assembly (DCA) that includes an illuminator and a sensor array, a shared storage capacitor using a regulated voltage from a voltage regulation module (VRM); and
providing power from the shared storage capacitor to the illuminator and the sensor array during an exposure window of the DCA in which the illuminator emits light into a local area and the sensor array detects the light.

20. The method of claim 19, further comprising:
providing the power from the shared storage capacitor to the illuminator and the sensor array that is more than a power level output by the VRM.
